(19) United States
(12) Patent Application Publication
(10) Pub. No.: US 2006/0081412 A1
(43) Pub. Date: Apr. 20, 2006

(54) System and method for combined microseismic and tiltmeter analysis

(75) Inventors: Chris Wright, Mill Valley, CA (US); Eric Davis, El Cerrito, CA (US); Larry Griffin, Spring, TX (US); Kevin Fisher, Katy, TX (US); George King, Richmond, TX (US); Norman Warpinski, Albuquerque, NM (US); James Ward, San Francisco, CA (US); Etienne Samson, Pacifica, CA (US)

Correspondence Address: HAYNES AND BOONE, LLP, 901 MAIN STREET, SUITE 3100, DALLAS, TX, 75202, US

(73) Assignee: Pinnacle Technologies, Inc., San Francisco, CA (US)

(21) Appl. No.: 11/080,591

(22) Filed: Mar. 15, 2005

Related U.S. Application Data
(60) Provisional application No. 60/553,876, filed on Mar. 16, 2004.

(51) Int. Cl. G01V 1/40; G01V 1/00

(52) U.S. Cl. 181/104; 181/108

(57) ABSTRACT

A system and method for monitoring geophysical processes is disclosed. The system may include a component array located within the bore hole of the active well, or, alternatively, in the bore hole of a nearby offset well, or, alternatively, in multiple shallow boreholes in the surface around the active well. The system may include a sensor array located within a bore, wherein the sensor array has at least one tilt sensor and at least one microseismic sensor, a transmitter in communication with the at least one tilt sensor and the at least one microseismic sensor, and a receiver in communication with the transmitter. In one embodiment, data comprising tiltmeter data and microseismic data from a sensor during at least one geophysical process is received. The microseismic data is analyzed to ascertain a location of each microseismic event of a plurality of microseismic events isolated from the microseismic data, and the tiltmeter data is analyzed to ascertain orientation and dimension of a fracture developed during said at least one geophysical process.

### CROSS REFERENCE TO RELATED APPLICATIONS

This patent application is a non-provisional of U.S. Provisional Patent Application No. 60/553,876, filed on Mar. 16, 2004, and entitled “Seismic Mapping Tool Incorporating Seismic Receivers and Tiltmeters,” which is incorporated by reference herein in its entirety.

### FIELD OF THE INVENTION

The invention relates to the field of tiltmeter systems and microseismic systems, and, more particularly, to a combined microseismic and tiltmeter system for treatment and offset wells and shallow surface boreholes for monitoring geophysical processes.

### BACKGROUND OF THE INVENTION

For a variety of applications, fluids are injected into the earth, such as for hydraulic fracture stimulation, waste injection, produced water re-injection, or for enhanced oil recovery processes like water flooding, steam flooding, or CO₂ flooding. In other applications, fluids are produced, i.e. removed, from the earth, such as for oil and gas production, geothermal steam production, or for waste clean-up. As an example, hydraulic fracturing is a worldwide multi-billion dollar industry, and is often used to increase the production of oil or gas from a well. Additionally, some processes excavate rock from the earth using fluids, chemicals, explosives or other known means.

Surface, offset-well, and treatment-well tiltmeter fracture mapping has been used to estimate and model the geometry of formed hydraulic fractures, by measuring fracture-induced rock deformation. Surface tilt mapping typically requires a number of tiltmeters, each located in a near-surface offset bore, which surround an active treatment well that is to be mapped. Microseismic hydraulic fracture mapping is currently performed using an array of seismic receivers (triaxial geophones or accelerometers) deployed in a well offset to the treatment well. These sensors are used to map a hydraulic fracture in a manner completely separate and independent of deformation monitoring performed with tiltmeter systems.

### BRIEF DESCRIPTION OF THE DRAWINGS

FIG. 1 illustrates a partial cutaway view of the deployment of one embodiment of the present invention.

FIGS. 2A and 2B each illustrate embodiments of a combined microseismic and tiltmeter system.

FIG. 3 illustrates a component that can be used in one embodiment of the present invention.

FIG. 4 is a flow diagram of an exemplary method according to one embodiment of the present invention.

FIG. 5 is a flow diagram of a method for analyzing fracture dimension and depth according to one embodiment of the present invention.

FIG. 6 is a flow diagram of an exemplary method for analyzing combined tiltmeter and microseismic data according to one embodiment of the present invention.

FIG. 7 is a user interface for facilitating display of processing results, in accordance with one embodiment of the present invention.

FIG. 8 is a user interface for facilitating display of combined microseismic and tilt fracture maps, in accordance with one embodiment of the present invention.

FIG. 9 is a diagrammatic representation of a machine in the exemplary form of a computer system within which a set of instructions may be executed.

### DETAILED DESCRIPTION

The invention relates to the field of tiltmeter systems and microseismic systems, and, more particularly, to a combined microseismic and tiltmeter system for treatment and offset wells and shallow surface boreholes for monitoring geophysical processes. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Further, the drawings are used to facilitate the present disclosure, and are not necessarily drawn to scale.

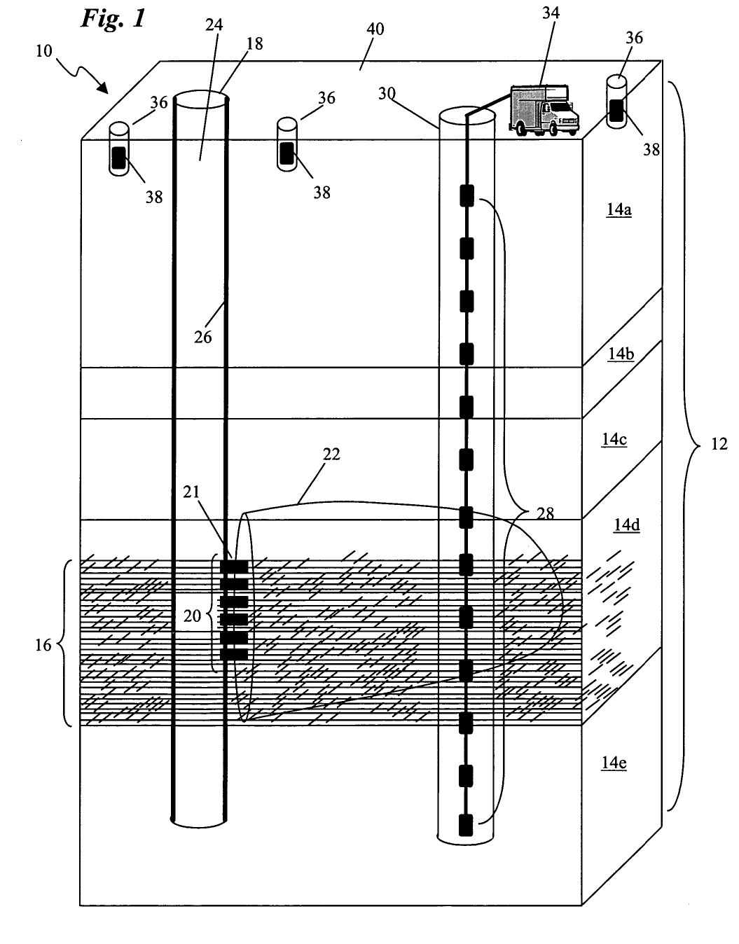

Referring now to FIG. 1, a partial cutaway view 10 is shown with a treatment well 18 that extends downward into strata 12, through one or more geological layers 14a-14e. A fracture zone 22 is formed within a previously formed perforation region 20 in the treatment well 18, such as to extend into one or more pay zones 16 within the strata 12.

The preparation of treatment well 18 for hydraulic fracturing typically comprises drilling a bore 24, cementing a casing 26 into the well to seal the bore 24 from the geological layers 14, and creating perforations 21. Perforations 21 are small holes through the casing 26, and the perforations 21 are often formed with an explosive device. The location of perforations 21 is at a desired depth within the well 24, which typically is at the level of a pay zone 16. A pay zone 16 may consist of oil and/or gas, as well as other fluids and materials that have fluid-like properties.

Hydraulic fracturing generally comprises pumping fluid down a treatment well 18. The fluid escapes through the perforations 21, and into the pay zone 16. The pressure created by the fluid is greater than the in situ stress on the rock, so fractures (cracks, fissures) are created. The resulting fractures creates the fracture zone 22.

The subsurface injection of pressurized fluid results in a deformation to the subsurface strata and changes in pressure and stress. This deformation may be in the form of a large planar parting of the rock, in the case of hydraulic fracture stimulation, or other processes where injection is above formation parting pressure. The resultant deformation may also be more complex, such as in cases where no fracturing is occurring, wherein the subsurface strata (rock layers) compact or swell, such as, for example, due to the poroelastic effects from altering the fluid pressure within the various rock layers. Additionally, the induced deformation field radiates in all directions.

Proppant is then pumped into the prepared well 18. Proppant is often sand, although other materials can be used. As the fluid used to create the fracture leaks off into the rock via natural porosity, the proppant creates a conductive path for the oil/gas to flow into the well 18.

A component array 28 of microseismic sensors and tiltmeter sensors may be placed in an offset well 26 to record data at different depths within the offset well 26 during the fracture process within the treatment well 18. In one embodiment, the component array 28 is coupled to a wireline 32, which extends to the surface, and may be connected to a wireline truck 34.

Component array 28 may be located at depths that are comparable to the fracture region, e.g. such as within the fracture zone, as well as above and/or below the fracture zone 22. For example, for a fracture at a depth of 5,000 feet, with an estimated fracture height of 300 feet, a component array having a span larger than 300 feet, e.g. such as an 800 foot string array, may be located in an offset hole near the active well. The use of a number of tilt sensors, located above, within, and below a fracture zone 22, aids in estimating the extent of the formed fracture zone.

The distance between an active well and an offset well in which a component array is located is often dependent on the location of existing wells, and the permeability of the local strata. For example, in certain locations, the surrounding strata has low fluid mobility, which requires that wells are often located relatively close together. In other locations, the surrounding strata has higher fluid mobility, which allows gas wells to be located relatively far apart.

Microseismic sensors, such as geophones and accelerometers, are sensitive listening devices that detect the seismic energy that is generated when the ground slips as a result of a hydraulic fracturing or other injection or production process. These devices detect the vibrations along a defined axis (which allows for orientation of the vibration) and then appropriate electronics on the receiver array transmit the data (sometimes called events) back to the surface for analysis and processing. An alternate monitoring scheme is to use a hydrophone (essentially a microphone) in the receiver to help detect small compressional waves. Data from the geophones, accelerometers, and hydrophones are transmitted up a fiber-optic wireline to a data acquisition system for recording and then to a data processing system for analysis. Analysis consists of spatially locating the events in space and presenting those results as a map of events marked on a map which may consist of a projection from the wellbore to the earth's surface and also a graph or picture of the fracture as viewed from the side (from which dimensions are seen).

Another placement of an embodiment of the present invention is in a combined surface tilt meter and microseismic array where one tiltmeter sensor and one microseismic sensor 38 are placed in each of numerous shallow bores 36 to record the tilt of the surface region 40 at one or more locations surrounding the treatment well 18 and any microseismic data that reaches the surface. The surface bores 36 have a typical depth of ten to forty feet. Tilt data from a treatment-well fracture process that are collected by the sensors 38 can be used to estimate the orientation and dip of the formed fracture zone 22, as well as other process data. Microseismic data collected by the sensors 38 are used to locate seismic events associated with the downhole process being monitored in order to estimate extent of the process.

As noted above, the combined tiltmeter and microseismic system can be used to monitor any downhole process involving fluid flow, heating, excavation, or any other process associated with stress changes and deformation of the subsurface environment. Fluid flow processes include fracturing, production, waterflooding and other secondary recovery processes, waste injection (drill cuttings, CO₂, hazardous wastes, among others), solution mining, migration of fluids, and many other processes associated with minerals extraction, environmental technology, fluid storage, or water resources. Heating includes secondary oil recovery processes using steam or other heat sources (or alternately cold sources), heat generated by nuclear wastes or other exothermic waste processes, or various other geophysical processes that generate heat. Excavation includes mining, cavity completions, jetting, and other processes that remove material from the subsurface. Other processes include numerous applications for monitoring the subsurface around dams, near faults, around volcanoes, or associated with any deformation-inducing geologic or geophysical process.

In addition to hydraulic fracturing, there are many other subsurface processes that induce deformation and micro-earthquakes, and these processes have also been monitored using tiltmeters or microseismic systems. The analysis of the data from these monitoring tests proceeds in the same manner as illustrated for a hydraulic fracture, except that the model used to extract the relevant information will change to fit the process being monitored (e.g., poro-elastic, thermo-elastic, chemical swelling, other elastic or non-elastic processes).

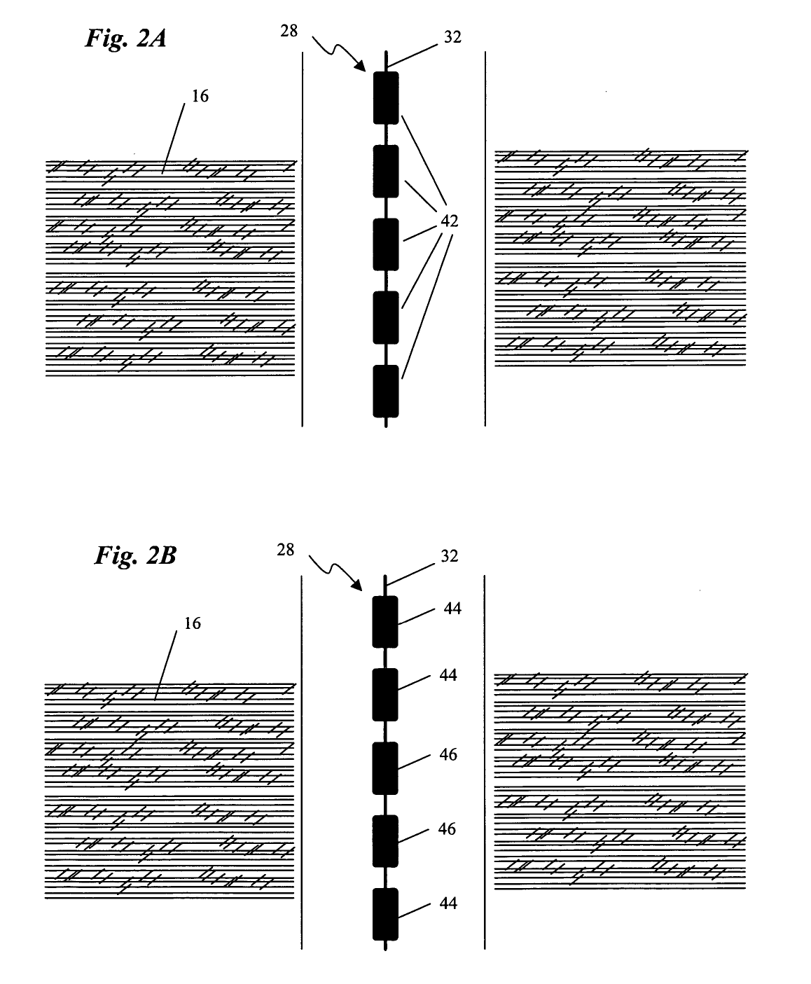

Referring now to FIG. 2A, an example component array 28 is shown in accordance with one embodiment of the invention. In this embodiment, component array 28 may comprise multiple components 42, which are deployed within the offset well 26. In one embodiment, component 42 comprises a single housing that contains tilt sensors and microseismic sensors. In another embodiment, component 42 is a single sensor that measures both tilt and microseismic data.

Referring now to FIG. 2B, an example component array 28 is shown in accordance with another embodiment of the invention. In this embodiment, component array 28 comprises multiple components 44, 46, which are deployed within the offset well 26. The components 44 may be interspersedly coupled to components 46 via wireline 32 or via direct connection of two sensor housings. In one embodiment, the components 44 further comprise microseismic sensors only, while the components 46 further comprise tilt sensors only.

In other alternate embodiments, any combination of components 44, 46 may be used, as well as any combination of components 42, 44, and 46 within a single component array 28. The respective components 42, 44, and 46 of component array 28 may be placed such that one or more components are located above, below, and/or within an estimated pay zone region 16, in which a perforation zone 20 is formed or a fracturing or other subsurface process is being monitored.

The component array 28 collects continuous data from the tilt sensors and the microseismic sensors and transmits this data back to the surface via the wireline 32, via permanent cabling, via wireless connectivity, or via memory storage, if or when the components 42, 44, 46 are returned to the surface. For permanent or semi-permanent applications, the combined tiltmeter and microseismic system may be deployed on tubing, on coiled tubing, on the outside of casing, on rods, or on a wireline or other cabling system and may be cemented in place (permanent application) or otherwise secured.

In a further embodiment, component array 28 may be used in shallow boreholes. In this embodiment, a single station of components 42, or components 44, 46, or any combination of the foregoing, may be deployed in shallow boreholes near a treatment well.

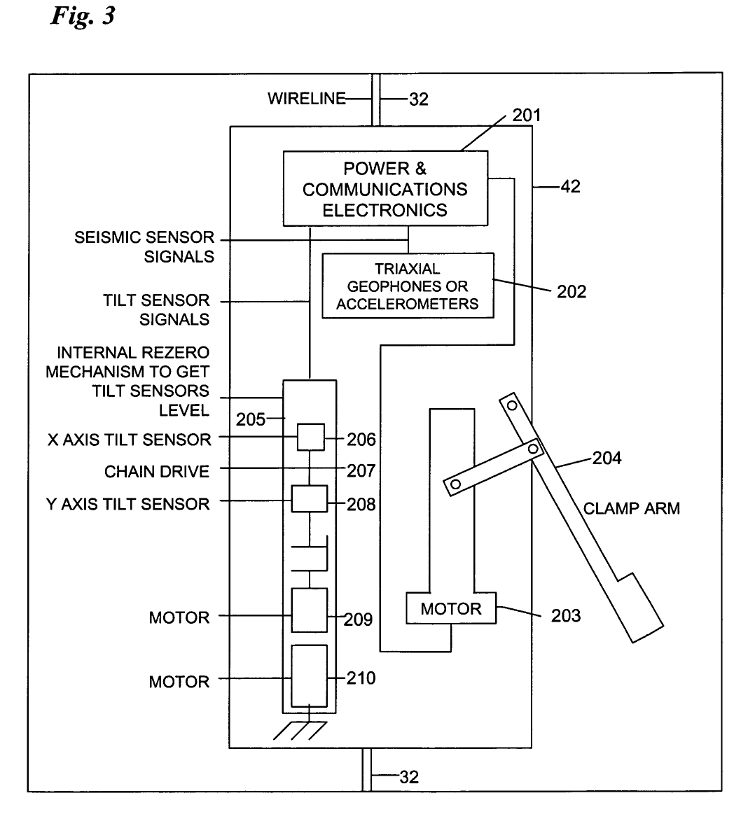

Referring now to FIG. 3, a combined microseismic and tiltmeter component 42, according to one embodiment of the present invention, is shown. Component 42 comprises a plurality of tilt sensors, such as, an “x” axis tilt sensor 206 and a “y” axis tilt sensor 208 coupled through a link, such as, a chain drive 207. The tilt sensors 206, 208 are able to detect changes in angle over time.

In one embodiment, the component 42 further comprises a tilt sensor leveling assembly 205, by which the tilt sensors 206, 208 are leveled before a fracture operation. The tilt sensor leveling assembly 205 provides a simple installation for deep, narrow boreholes. Once each component 42 is in place, motors 209, 210 are capable of bringing the sensors 206, 208 substantially close to vertical level. Motors 209, 210 may also be capable of keeping the sensors in their operating range, even if large disturbances move the component 42.

In one embodiment, the tilt sensors 206, 208 are rotated near the center of their operating range so that they may begin recording movements of the component 42. If the sensors 206, 208 approach the limit of their range, the motors 209, 210 may rotate the sensors back near the center of their range.

The component 42 may further comprise an array of seismic receivers or sensors 202, such as triaxial geophones or accelerometers. These sensors 202 are used to map a hydraulic fracture in a manner completely separate and independent of deformation monitoring performed with the tilt sensors 206, 208. Microseismic mapping uses the sensors 202 mentioned above to detect micro-earthquakes that are induced by changes in stress and pressure (e.g., slippages along existing planes of weakness) as a result of a hydraulic fracturing or other injection or production process or tensile cracking due to excavation, temperature changes or other processes. The plurality of these micro earthquakes, tensile cracks, or other such processes inducing seismic noise are termed “events.”

The microseismic sensors may have a predetermined known orientation for accurate measurement of the events, which may be accomplished by orienting from multiple sources having predetermined known locations, from an assumed position of a number of events, or from an on-board monitoring sensor such as a gyroscope.

In one embodiment, in order to determine the orientation of the tilt sensors 206, 208 in their final position with respect to the microseismic sensors 202, which is required if the sensor orientation is to be used in the analysis, the microseismic sensors 202 must either be fixed with respect to the orientation of the tilt sensors 206, 208, or the relative position of the two sensor types must be measured inside each component 34 through an independent sensor (not shown). Alternatively, if the tilt sensors 206, 208 have sufficient range and precision, mapping may be obtained without need for a mechanism to center the sensors.

In one embodiment, a motor 203 coupled to a clamp arm 204 is located within the housing of the component 42. The motor 203 can actuate, causing clamp arm 204 to extend to walls of the well. Alternatively, it is to be understood that other means to secure the component 42 onto the walls of the well may be used with the present invention, including, but not limited to, centralizers, magnets, packers, bladders, coiled tubing, cement and other securing means. It must be noted, however, that having contact points along the length of the component 42 makes it more difficult to determine exactly where the tilt is being measured, so one embodiment of component 42 would accommodate both the stiffness requirements and the contact requirements of both the microseismic sensor and the tilt sensor.

In a further embodiment, the component 42 may also comprise a power and communications electronics module 201 coupled to the leveling assembly 205 and the microseismic sensors 202. The power and communications electronics module 201 provides a power supply for the tilt sensors 206, 208 and the microseismic sensors 202. The module 201 may be configured to receive the tilt sensor signals from the tilt sensors 206, 208 and the seismic sensor signals from the seismic sensors 202, to process the received data, and to transmit the data to the surface via the wireline 32, or other transmission devices.

Data may be recorded and stored in the component 42 for collection and analysis at a later date, or may be transmitted via radio link or cable link to a central location where the data from multiple instruments is collected and stored.

In another embodiment, within each tiltmeter assembly 205, sensor signals are processed through a processing module (not shown), such as an analog processing module, which measures and amplifies the tilt sensor signals from the two sensors 206, 208 and transmits the signals to the power and communications electronics module 201. In a further embodiment, the power and communication electronics module 201 may be capable of multiplexing or combining the data into a single data format.

The microseismic sensor assemblage consists of any number of seismic measurement sensors (typically three) such as accelerometers or geophones configured to detect triaxial (3 orthogonal channels) seismic data, biaxial (2 orthogonal channels, typically horizontal) seismic data, compressional data as from a hydrophone, or shear wave data as from a shear-wave detection sensor. A processing methodology similar to that used for the tiltmeters is employed for the microseismic data to obtain the signals from the microseismic sensors.

In one embodiment, the microseismic sensor within component 42 has a first resonant frequency higher than the highest frequency to be measured, and the tilt sensors within component 42 are designed to have a first mode above that required by the microseismic system.

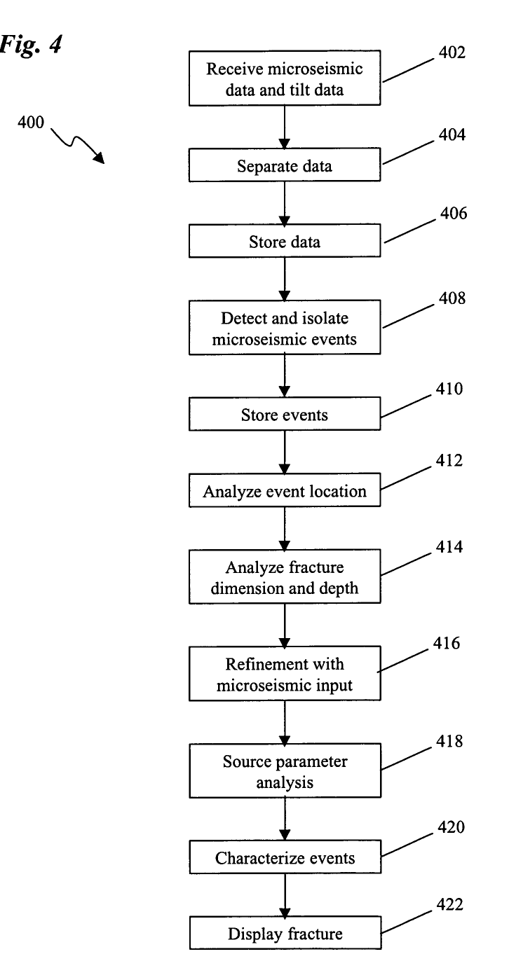

Referring now to FIG. 4, an example flow diagram 400 of a method for analyzing microseismic and tiltmeter data in one embodiment of the present invention is shown. At step 402, the microseismic and tiltmeter data is received. The microseismic and tiltmeter data may be received by a wireline truck, or any computer system. In another embodiment, the wireline truck transmits the data to a treatment control van, mobile unit, or other processing system. The data may be sent as a digital signal, with microseismic signals being provided on one line, such as a fiber optic cable, and tilt signals coming up a separate electrical conductor. In one embodiment, the microseismic and tiltmeter data may be multiplexed together.

If the microseismic data and tiltmeter data are not received independently, the received data is separated into microseismic data and tilt data, step 404. In one embodiment, the data is de-multiplexed. At step 406, the microseismic data is stored and the tilt data is stored. In one embodiment, the microseismic data may be stored in SEG2 format and the tilt data may be stored in a binary self-defining file structure.

At step 408, the microseismic data is analyzed to detect and isolate microseismic events, such as micro-earthquakes. This analysis uses well-known earthquake detection and analysis techniques. In one embodiment, the events are isolated by examining the differences in the short and long term average of the microseismic data stream. The background noise is examined, and a threshold above the level of the background noise is determined. When the level of the data stream exceeds the threshold, the event as indicated by the high level is isolated. At step 410, the isolated events are stored.

At step 412, the events are analyzed and the location of each event is ascertained based on that analysis, for example using a method described in detail in Warpinski, N. R., Branagan, P. T., Peterson, R. E., Wolhart, S. L., and Uhl, J. E., “Mapping Hydraulic Fracture Growth and Geometry Using Microseismic Events Detected By A Wireline Retrievable Accelerometer Array,” SPE40014, 1998 Gas Technology Symposium, Calgary, Alberta, Canada, Mar. 15-18, 1998.

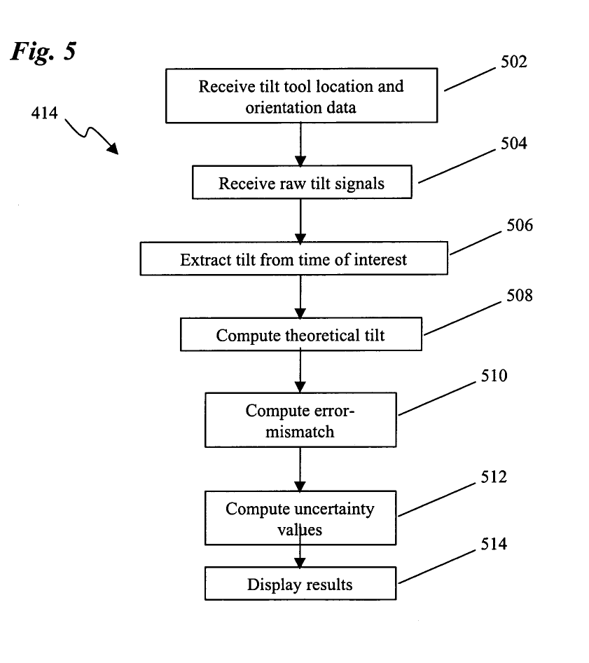

At step 414, fracture information analysis may be performed on the tilt data. This analysis compares the measured signals with the signals that are predicted from a model. Some examples of prediction models include the Okada Model and the Green & Sneddon model. This analysis may include, for example, fracture dimension and depth analysis, as described in further detail below in connection with FIG. 5. The analysis may be performed by comparing the measured signals with a prediction of signals from a model, then changing the fracture parameters in the model to see if the predicted signals more closely match the measured signals. Different parameters within the models may be changed in accordance with detecting of desired characteristics of the fracture information.

The fracture information analysis is refined using the retrieved microseismic data to ascertain dimensions of the fracture in areas far from the observation well, step 416. If the microseismic data can add constraints to the model used in the tilt analysis, that improves the results of the tilt analysis. As an example, the tilt analysis alone may be unable to determine a fracture length, because for a particular situation the theoretical signals do not significantly change with a simultaneous small increase in length combined with a small decrease in the fracture height. However, if the microseismic data can be used to constrain the height within some bounds, the tilt can then determine what range of fracture lengths would be consistent with those heights.

At step 418, source parameter analysis may be performed. Source parameter analysis attempts to analyze the microseismic data for more than just the location of the seismic event. For instance, direction in which the slip occurred, the energy released, the area of the slip surfaces, and other parameters may be detected using common earthquake detection and analysis techniques. At step 420, each detected event may then be characterized. Characterizing events groups the events according to space and time to show how growth of a fracture progresses. Some events do not indicate fracture growth and may be characterized as outliers. Some event groupings may indicate that the fracture intersected an existing fault, or a pre-existing hydraulic fracture. The groupings may show, for instance, that the fracture quickly grows in length, then grows in height later on, or that one wing grows before the other. Other forms of characterization are also contemplated.

The fracture and results of the fracture and source parameter analysis, or any combination of the foregoing, may be displayed to a user via a user interface, step 422.

Referring now to FIG. 5, a flow diagram 414 of a method for analyzing fracture dimension and depth from tiltmeter data using the microseismic data as an additional constraint is shown according to one embodiment of the present invention. At step 502, tilt tool location, such as the well location and depth of the tool, and orientation data, such as the compass direction in which the tool is facing, is received by the system. At step 504, the raw tilt signals may be received. The raw tilt signals are data representing the change in angle of each sensor over time, and may be received in digital form.

At step 506, the tilt is extracted from the time of interest. The extraction converts the change in angle of each sensor over time to a single value representing the change in angle during the time period covered by the model. In one embodiment, the time period commences when the hydraulic fracture treatment starts and continues until it ends.

Using a predetermined fracture model, a theoretical tilt is computed, step 508. The fracture model used for the theoretical tilt computation is a mathematical description of the fracture system. This model allows one to calculate what the tiltmeters should record for a given fracture system. The model runs until the predicted tiltmeter response matches the measured response as close as possible. The models used are well-known to those skilled in the art.

In one embodiment, the theoretical tilt is computed using initial fracture constraints such as the perforation depth, the location of the treatment well, and the orientation of the fracture calculated using the stored microseismic event information. Most constraints, like the perforation depth, and well location are given as part of the treatment design information. For the fracture orientation, the microseismic data must be analyzed for event location. The aggregate of the event locations provides a fracture orientation (and typically also some uncertainty value). The constraints are used to determine an initial estimated value for the fracture parameters such as depth, height, azimuth, dip, length, width, easting, northing, strike slip and dip slip are determined. Any of these parameters that have an unknown value will be inverted on during the analysis in order to determine an estimated value. The additional constraints provided by the microseismic analysis allow more precise determination of the unknown parameters.

At step 510, an error-mismatch of the theoretical tilt versus the measured tilt is computed using well-known techniques. In one embodiment, the ‘steepest descent’ optimization routine may be used to minimize the error. The fracture parameters are refined using the additional far field constraints on the fracture dimensions. The additional far field constraints are received from the microseismic results. For instance, the height constraints from the microseismic results could be used, or the data may indicate that the model should include more than one fracture, and it would show where the location and orientation of the second fracture.

At step 512, uncertainty values are computed. These values may be computed, for example, using Monte-Carlo statistical analysis or multi-dimensional error surface calculations. At step 514, the results may displayed to a user via a user interface. In one embodiment, the best fit results produced by the optimization routine and the uncertainty values produced by the uncertainty analysis are displayed.

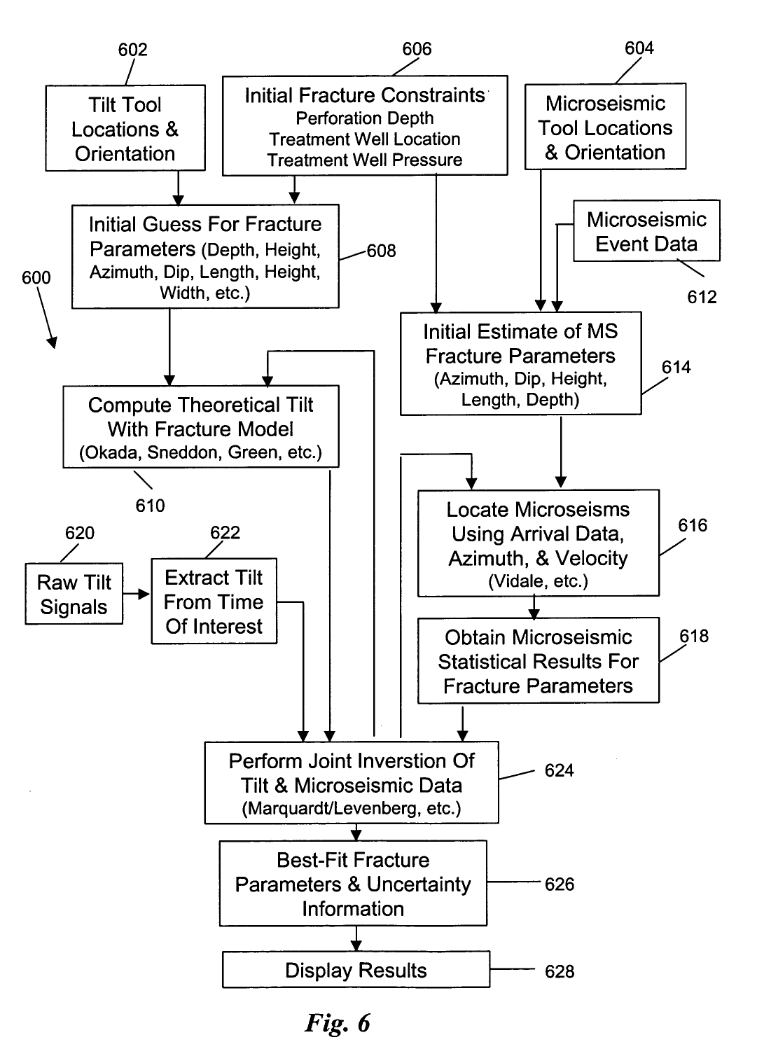

Referring now to FIG. 6, a flow diagram 600 of a method for analyzing tiltmeter and microseismic data in a joint inversion, such that all appropriate data are analyzed together is shown according to one embodiment of the present invention. At step 602, tilt tool location and orientation data is received. At step 604, microseismic tool location and orientation data are received. Initial fracture constraints such as the perforation depth, the fracture pressure, and the location of the treatment well may also be received, at step 606. At step 608, an initial estimate for the fracture parameters such as depth, height, azimuth, dip, length, width, easting, northing, strike slip and dip slip, is performed using the received initial fracture constraints and/or initial microseismic data. The theoretical tilt is computed using the resulting fracture model, step 610.

At step 612, microseismic event data is received. At step 614, the microseismic event data is used to obtain an initial estimate of fracture parameters. At step 616, a microseismic location procedure, such as, for example, a location procedure using a method such as that described in detail in Warpinski, N. R., Branagan, P. T., Peterson, R. E., Wolhart, S. L., and Uhl, J. E., “Mapping Hydraulic Fracture Growth and Geometry Using Microseismic Events Detected By A Wireline Retrievable Accelerometer Array,” SPE40014, 1998 Gas Technology Symposium, Calgary, Alberta, Canada, Mar. 15-18, 1998 is performed. This step locates the microseismic data using known procedures for finding the optimum location of an event based on arrival times and velocities for compressional and shear waves, as well as other waves, if detected. In this embodiment, a statistical or other analysis of the microseismic location data can also be performed to extract appropriate geometric parameters from the locations of the microseismic data, step 618.

In one embodiment, the raw tilt signals are also received, step 620, and the tilt is extracted from the time of interest, step 622. The extracted tilt is used for comparison with the theoretical tilt and the subsequent inversion process.

Ate step 624, an inversion procedure, such as the Marquardt-Levenberg technique, is now applied to the tiltmeter and microseismic data. In this embodiment, the difference between the theoretical fracture model and the tilt data provides the error misfits for the tilt vectors, and the difference between the theoretical fracture model and the microseismic statistical geometric parameters using relocated data provides the error misfits for the microseismic vectors. This known type of inversion procedure proceeds in an iterative manner to obtain the fracture geometric parameters and formation velocities that minimize the misfits of the data in some prescribed manner. At each iteration, the inversion recalculates the theoretical tilts and relocates the microseismic data.

At step 626, the inversion produces best-fit fracture parameters and uncertainty data. These results can be displayed in any appropriate manner, step 628.

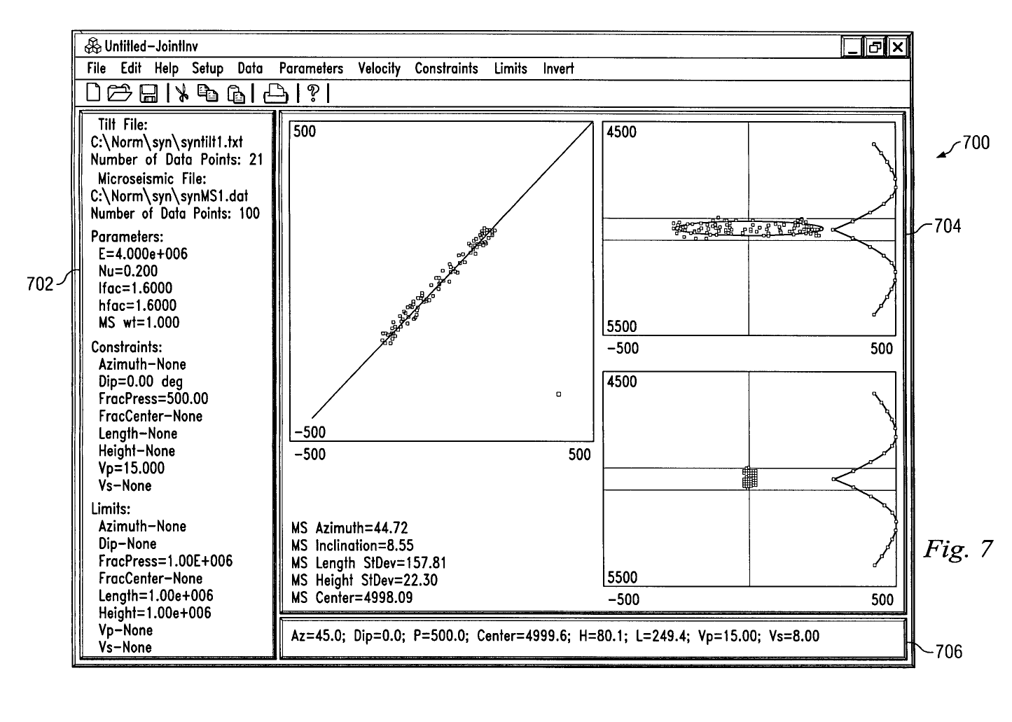

FIG. 7 illustrates one embodiment of a user interface for facilitating the display of the extracted fracture parameters from the joint inversion procedure. As illustrated in FIG. 7, in one embodiment, the user interface 700 comprises a window 702, which facilitates the display of data including a comparison of the tilt data (symbols) with the theoretical tilt distribution (line), a window 704, which facilitates the display of a plot of the microseismic data in plan, side, and edge view compared to the theoretical model, and a window 706, which facilitates the display of other various information related to the inversion procedure.

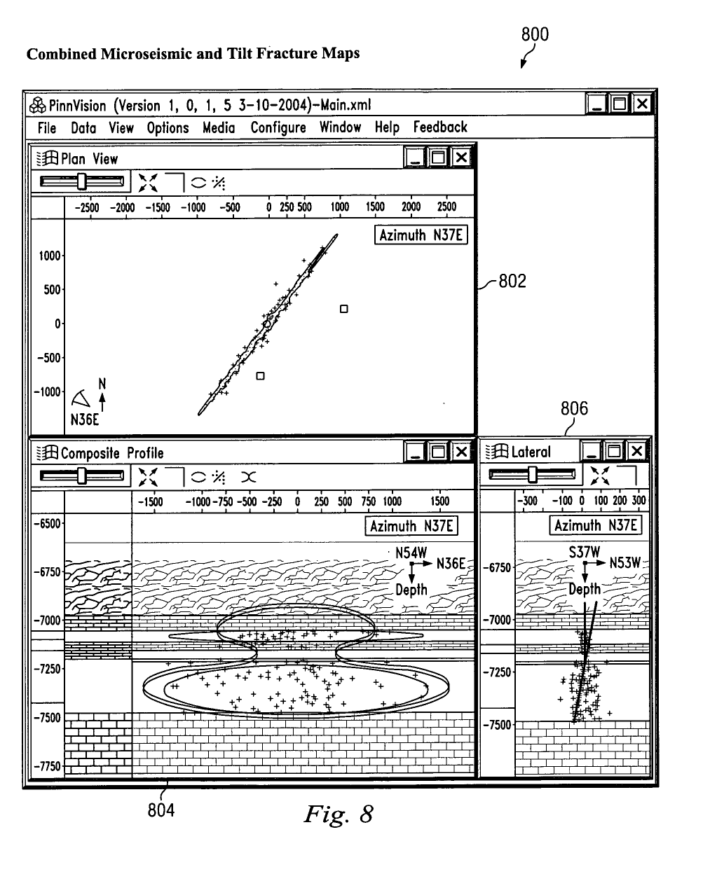

In another embodiment of the present invention, the tiltmeter and microseismic data are also analyzed in conjunction with the pressure and/or temperature in the treatment well. In such an application, the pressure is measured in the treatment well using well-known pressure sensing tools at either the surface or in the wellbore. The pressure data is also analyzed using any physical modeling of the fracture or other process to deduce the fracture parameters. These results can be used as another constraint to the theoretical tilt model, another vector parameter in the joint inversion, or another display of the fracture results, such as, for example, in a user interface illustrated in connection with FIG. 8.

FIG. 8 is a user interface for facilitating display of combined microseismic and tilt fracture maps. As illustrated in FIG. 8, in one embodiment, the user interface 800 comprises a plan view window 802, which facilitates the display of a plan view of the combined microseismic and tilt fracture map, a composite profile window 804, which facilitates the display of a composite view of the combined microseismic and tilt fracture map, and a lateral view window 806, which facilitates the display of a lateral view of the combined microseismic and tilt fracture map.

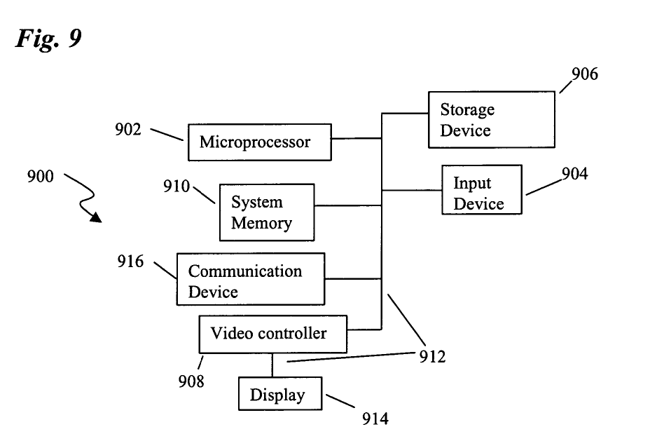

It will also be understood by those having skill in the art that one or more (including all) of the elements/steps of the present invention may be implemented using software executed on a general purpose computer system or networked computer systems, using special purpose hardware-based computer systems, or using combinations of special purpose hardware and software. Referring to FIG. 9, an illustrative node 900 for implementing an embodiment of the method is depicted. Node 900 includes a microprocessor 902, an input device 904, a storage device 906, a video controller 908, a system memory 910, and a display 914, and a communication device 916 all interconnected by one or more buses 912. The storage device 906 could be a floppy drive, hard drive, CD-ROM, optical drive, or any other form of storage device. In addition, the storage device 906 may be capable of receiving a floppy disk, CD-ROM, DVD-ROM, or any other form of computer-readable medium that may contain computer-executable instructions. Further communication device 916 could be a modem, network card, or any other device to enable the node to communicate with other nodes. It is understood that any node could represent a plurality of interconnected (whether by intranet or Internet) computer systems, including without limitation, personal computers, mainframes, PDAs, and cell phones.

A computer system typically includes at least hardware capable of executing machine readable instructions, as well as the software for executing acts (typically machine-readable instructions) that produce a desired result. In addition, a computer system may include hybrids of hardware and software, as well as computer sub-systems.

Hardware generally includes at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards, for example.

Software includes any machine code stored in any memory medium, such as RAM or ROM, and machine code stored on other devices (such as floppy disks, flash memory, or a CD ROM, for example). Software may include source or object code, for example. In addition, software encompasses any set of instructions capable of being executed in a client machine or server.

Combinations of software and hardware could also be used for providing enhanced functionality and performance for certain embodiments of the disclosed invention. One example is to directly manufacture software functions into a silicon chip. Accordingly, it should be understood that combinations of hardware and software are also included within the definition of a computer system and are thus envisioned by the invention as possible equivalent structures and equivalent methods.

Computer-readable mediums include passive data storage, such as a random access memory (RAM) as well as semi-permanent data storage such as a compact disk read only memory (CD-ROM). In addition, an embodiment of the invention may be embodied in the RAM of a computer to transform a standard computer into a new specific computing machine.

Data structures are defined organizations of data that may enable an embodiment of the invention. For example, a data structure may provide an organization of data, or an organization of executable code. Data signals could be carried across transmission mediums and store and transport various data structures, and, thus, may be used to transport an embodiment of the invention.

The system may be designed to work on any specific architecture. For example, the system may be executed on a single computer, local area networks, client-server networks, wide area networks, internets, hand-held and other portable and wireless devices and networks.

A database may be any standard or proprietary database software, such as Oracle, Microsoft Access, SyBase, or DBase II, for example. The database may have fields, records, data, and other database elements that may be associated through database specific software. Additionally, data may be mapped. Mapping is the process of associating one data entry with another data entry. For example, the data contained in the location of a character file can be mapped to a field in a second table. The physical location of the database is not limiting, and the database may be distributed. For example, the database may exist remotely from the server, and run on a separate platform. Further, the database may be accessible across the Internet. Note that more than one database may be implemented.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A system for monitoring a geophysical process, comprising:
a sensor array located within a bore, wherein the sensor array has at least one tilt sensor and at least one microseismic sensor;
a transmitter in communication with the at least one tilt sensor and the at least one microseismic sensor; and
a receiver in communication with the transmitter.

2. The system of claim 1, wherein the transmitter is a wireline.

3. The system of claim 1, wherein the transmitter transmits via wireless connectivity.

4. The system of claim 1, wherein the bore is within a well.

5. The system of claim 4, wherein the well is an active well.

6. The system of claim 4, wherein the well is an offset well.

7. The system of claim 1, wherein the bore is a shallow bore hole.

8. The system of claim 1, wherein the sensor array further comprises at least one tilt sensor interspersedly coupled to at least one microseismic sensor.

9. A system for monitoring a geophysical process, comprising:
a wireline within a bore;
a plurality of components coupled to the wireline, wherein at least one of the plurality of components comprises a tilt sensor and a microseismic sensor; and
a receiver in communication with the tilt sensor and microseismic sensor.

10. The system of claim 9 wherein the tilt sensor comprises an “x” axis tilt sensor and a “y” axis tilt sensor.

11. The system of claim 9, wherein the at least one of the plurality of components further comprises a tilt sensor leveling assembly.

12. The system of claim 11, wherein the tilt sensor leveling assembly further comprises at least one motor for enabling the tilt sensor to operate in a predetermined operating range for collection of tiltmeter data.

13. The system of claim 12, wherein the tilt sensor is coupled to the at least one motor through a chain drive.

14. The system of claim 12, wherein the at least one motor is capable of bringing the tilt sensor substantially close to vertical level.

15. The system of claim 9, wherein the microseismic sensor is a triaxial geophone.

16. The system of claim 9, wherein the microseismic sensor is an accelerometer.

17. The system of claim 9, wherein the microseismic sensor is configured to detect any of triaxial seismic data, biaxial seismic data, compressional data, and shear wave data.

18. The system of claim 9, wherein the microseismic sensor has a predetermined orientation to provide measurement of a plurality of seismic events.

19. The system of claim 9, wherein the microseismic sensor is fixed in relation to an orientation of the tilt sensor.

20. The system of claim 19, wherein a relative position of the microseismic sensor in relation to the tilt sensor is measured through an independent sensor.

21. The system of claim 9, wherein the at least one of the plurality of components further comprises a power module.

22. The system of claim 9, wherein the at least one of the plurality of components further comprises a communications module.

23. The system of claim 9, wherein the at least one of the plurality of components further comprises a motor and a clamp arm coupled to said motor.

24. A method for analyzing tilt data and microseismic data, comprising:
receiving data comprising tiltmeter data and microseismic data from a sensor during at least one geophysical process;
analyzing the microseismic data to ascertain a location of each microseismic event of a plurality of microseismic events isolated from the microseismic data; and
analyzing the tiltmeter data to ascertain orientation and dimension of a fracture developed during said at least one geophysical process.

25. The method of claim 24, further comprising:
separating the tiltmeter data and the microseismic data.

26. The method of claim 24, wherein the analyzing the microseismic data further comprises:
detecting and isolating the plurality of microseismic events;
storing the plurality of microseismic events; and
ascertaining the location of each microseismic event.

27. The method of claim 24, wherein the analyzing the microseismic data further comprises:
performing source parameter analysis on each microseismic event.

28. The method of claim 24, wherein the analyzing the tiltmeter data further comprises:
performing fracture dimension and depth analysis on the tiltmeter data; and
applying microseismic data related to each microseismic event to ascertain the orientation and dimension of the fracture.

29. The method of claim 28, wherein performing fracture dimension and depth analysis on the tiltmeter data further comprises:
receiving location data and orientation data of the sensor;
computing an error-mismatch value of a theoretical tilt computed using a predetermined fracture model and a measured tilt extracted from the tiltmeter data.

30. The method of claim 29, further comprising:
receiving initial fracture constraints of the fracture; and
performing an initial guess for a plurality of fracture parameters of the fracture using the initial fracture constraints to obtain a fracture model.

31. The method of claim 30, further comprising:
refining said plurality of fracture parameters using additional far field constraints.

32. The method of claim 24, further comprising:
receiving location data and orientation data of the sensor; and
computing a theoretical tilt using a predetermined fracture model, the location data and the orientation data.

33. The method of claim 32, further comprising:
extracting a measured tilt from the tiltmeter data; and
performing an inversion procedure on the tiltmeter data and the microseismic data using the theoretical tilt and the measured tilt to obtain best-fit fracture parameters and uncertainty values for the fracture.

34. A method for analyzing tilt data and microseismic data comprising:
receiving data comprising tiltmeter data and microseismic data from a sensor during at least one geophysical process;
receiving location data and orientation data of the sensor;
analyzing the microseismic data to ascertain a location of each microseismic event of a plurality of microseismic events isolated from the microseismic data;
extracting a measured tilt from the tiltmeter data;
analyzing the tiltmeter data to ascertain orientation and dimension of a fracture developed during said at least one geophysical process;
receiving initial fracture constraints of the fracture;
performing an initial guess for a plurality of fracture parameters of the fracture using the initial fracture constraints to obtain a fracture model;
computing a theoretical tilt using the fracture model;
computing an error-mismatch value of the theoretical tilt and the measured tilt;
refining said plurality of fracture parameters using additional far field constraints; and
performing an inversion procedure on the tiltmeter data and the microseismic data using the theoretical tilt and the measured tilt to obtain best-fit fracture parameters and uncertainty values for the fracture.

35. A system for monitoring a geophysical process, comprising:
means for receiving combined data comprising tiltmeter data and microseismic data from a component array comprising a plurality of components for collecting said tiltmeter data and said microseismic data during at least one geophysical process;
means for analyzing said microseismic data to ascertain a location of each microseismic event of a plurality of microseismic events isolated from said microseismic data;
means for analyzing said tiltmeter data to ascertain orientation and dimension of a fracture developed during said at least one geophysical process; and
means for displaying said fracture in at least one window of a user interface.

36. A computer readable medium containing executable instructions, which, when executed in a processing system, cause said processing system to perform a method comprising the steps of:
receiving data comprising tiltmeter data and microseismic data from a sensor during at least one geophysical process;
analyzing the microseismic data to ascertain a location of each microseismic event of a plurality of microseismic events isolated from the microseismic data;
analyzing the tiltmeter data to ascertain orientation and dimension of a fracture developed during said at least one geophysical process; and
displaying said fracture in at least one window of a user interface.
